(19) United States
(12) Patent Application Publication
(10) Pub. No.: US 2009/0039998 A1
(43) Pub. Date: Feb. 12, 2009

(54) Transformer structure

(75) Inventors: Chih-Shien Liu, Taoyuan Hsien (TW); Wen-Sen Hsien, Taoyuan Hsien (TW); Chih-Ming Hu, Taoyuan Hsien (TW)

Correspondence Address: Joe McKinney Muncy, PO Box 1364, Fairfax, VA, 22038-1364, US

(73) Assignee: FSP TECHNOLOGY INC.

(21) Appl. No.: 11/883,000

(22) Filed: Aug. 8, 2007

(51) Int. Cl. H01F 27/32

(52) U.S. Cl. 336/198

(57) ABSTRACT

The present invention is related to an improved transformer structure including a main body and, accommodated in the main body, a first winding frame and two winding frames. Hollow portions of the first winding frame and each of the second winding frames are combined with openings on the main body, for forming a primary side passage in a longitudinal direction and two secondary side passages in a lateral direction, so as to penetrate respectively a first magnetic material into the primary side passage and a second magnetic material into the two secondary side passages. Through the longitudinal primary side passage and the lateral secondary side passages, the primary and the secondary side winding can have a proper interval therebetween for achieving a stable output, so that a high voltage can be directly applied to the transformer for driving the large size LCD back light module for improving the efficiency.

### FIELD OF THE INVENTION

The present invention is related to an improved structure of transformer, and more particularly, to a transformer structure which alters the relative positions of primary winding frame and secondary winding frame for driving plural loads.

### BACKGROUND OF THE INVENTION

Conventionally, the back-light module is driven by plural parallel tubes, which are driven by plural single output transformer, so that a large amount of small-type transformers are need, thereby consuming lots of time for assembling and lots of occupied space and thus influencing the assembling speed and the size of product. Therefore, various improvements of the transformer structure are disclosed so that it can utilize fewer transformers to drive plural loads. For example, R.O.C Patent Publication No. 594808, entitled “A transformer and application in multi-tube voltage supplying circuit”, discloses a first winding tube and a second winding tube which are respectively wound by a first coil and plural second coils, which are mutually independent, and the first winding tube and the first coil are penetrated in the hollow space inside the second winding tube, so that the first coil and plural second coils can independently output electricity. Moreover, R.O.C. Patent No. M296461 discloses “A converter transformer”, which is constituted by a first winding frame and a core set, wherein the winding frame is wound by respectively a primary side winding and plural secondary windings and the core set has a first element and a second element, which are respectively a C-shaped core and an I-shaped core. The I-shaped core is penetrated into the hollow portion inside the winding frame and the C-shaped core is magnetic conductive element bridged across the winding frame and connected to the two ends of the I-shaped core. The above described disclosures both have the ability to drive more than one load. However, in the structures thereof, the low voltage side is covered the high voltage side, so that the low voltage feedback line of the low voltage side will cross the high voltage side winding and thus interfere thereof and also the stability of output voltage. Consequently, the present invention is to provide an improved transformer structure in view of the drawbacks described above.

### SUMMARY OF THE INVENTION

The object of the present invention is to provide a transformer in which the positions of primary side winding and secondary side winding are altered for preventing a feedback interference therebetween.

The present invention is related to an improved transformer structure including a main body having a first accommodating space and two second accommodating spaces. A first winding frame and two winding frames are respectively accommodated in the first winding frame and the two winding frames and are respectively wound by a primary coil and secondary side coils. The first winding frame and each of the second winding frames respectively have a hollow portion whose two ends has openings, so that the first winding frame and the first openings of the first accommodating space can form a primary side passage, and the second winding frames and the second openings of each of the second accommodating spaces can form two secondary side passages, thereby penetrating respectively a first magnetic material into the primary side passage and a second magnetic material into the two secondary side passages. Through the longitudinal primary side passage and the lateral secondary side passages, the primary side winding and the secondary side winding can form a transformer which can prevent the low voltage feedback line of the secondary side coil from being influenced by the high voltage coil for achieving a stable output, so that a high voltage can be directly applied to the transformer for driving the large size LCD back light module for improving the efficiency.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1A is a decomposition drawing of main body and winding frames of the present invention;

FIG. 1B is another decomposition drawing of main body and winding frames of the present invention;

FIG. 2A is a three-dimensional drawing of main body and winding frames of the present invention;

FIG. 2B is another three-dimensional drawing of main body and winding frames of the present invention;

FIG. 3A is a schematic view showing the installation of cores in the present invention; and

FIG. 3B is three-dimensional drawing of the present invention.

### DESCRIPTION OF THE PREFERRED EMBODIMENT

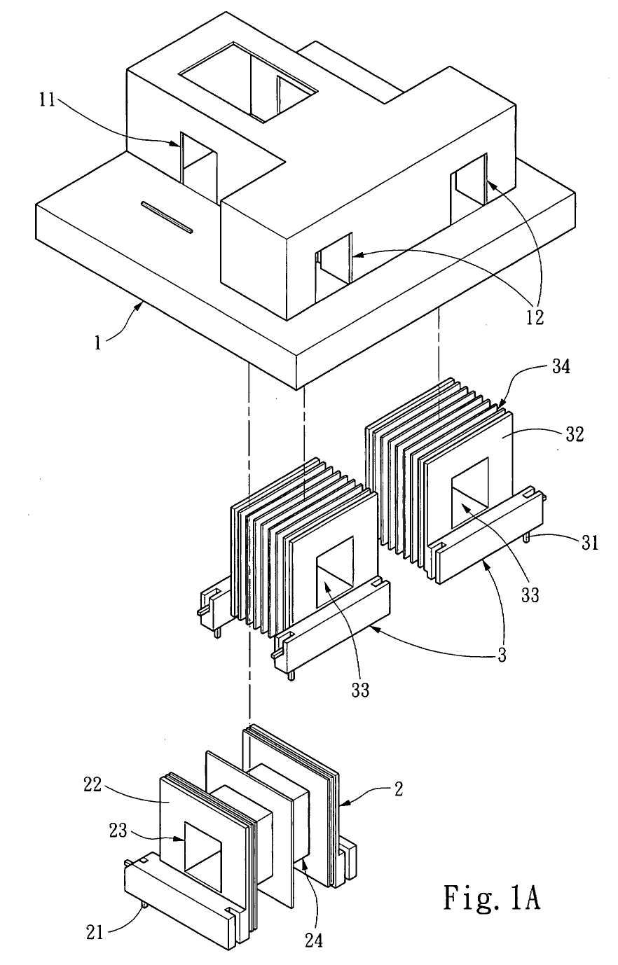

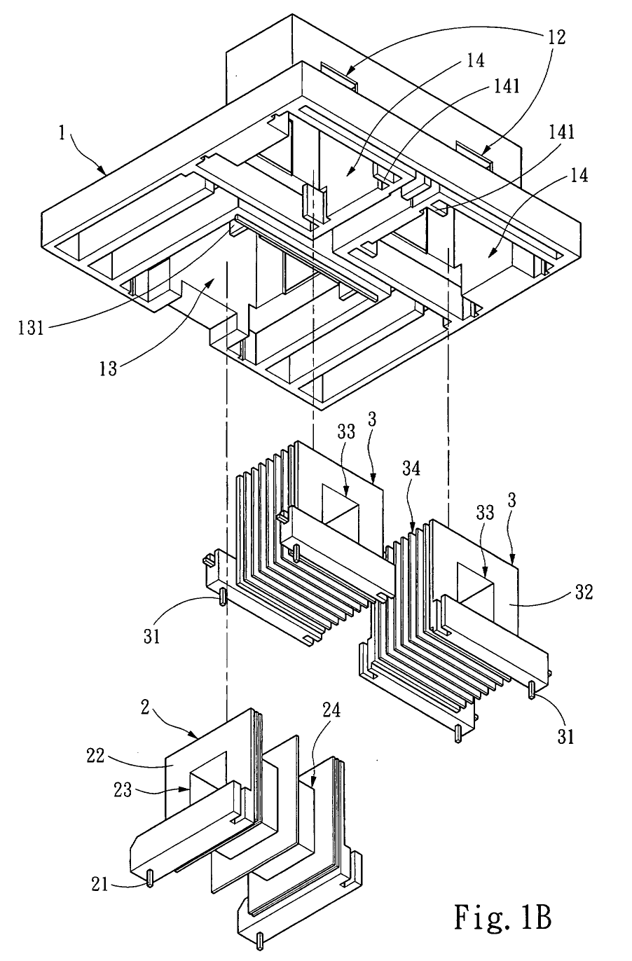

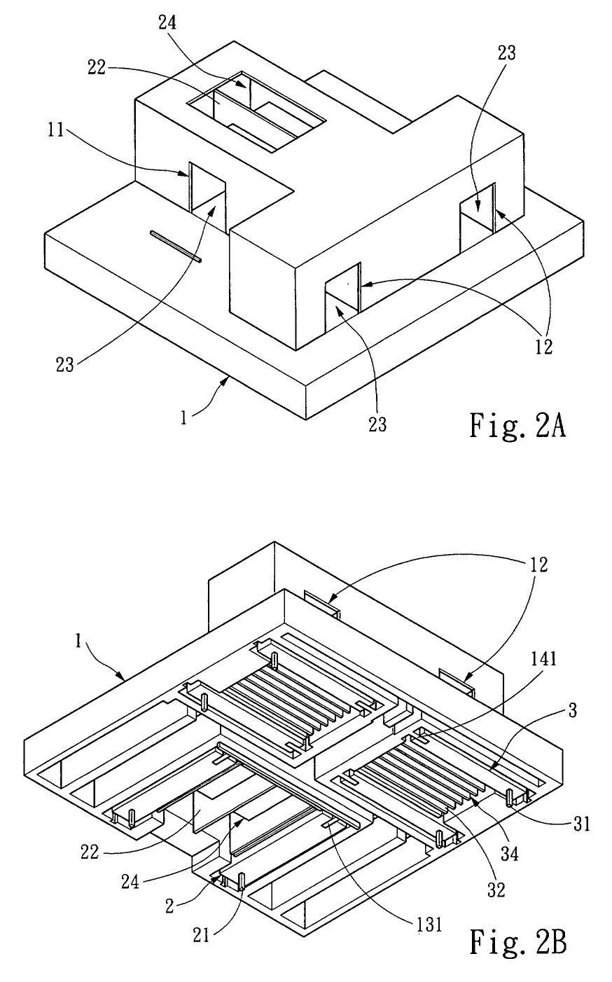

Please refer to FIGS. 1A, 1B and FIGS. 2A, 2B, which are three-dimensional drawings of the present invention in different angles according to a preferred embodiment. The improved transformer structure is constituted by a main body, and a first winding frame 2 and two second winding frames 3, which are mounted on the main body 1. The main body 1 has a first accommodating space 13 and two second accommodating spaces 14 mounted inside the main body, and the first winding frame 2 and the two winding frames 3 are respectively located in the first accommodating space 13 and the two second accommodating spaces 14. Moreover, the first accommodating space 13 and each of the second accommodating spaces 14 respectively have one or more positioning portion 131, 141 for fixing the first winding frame 2 and the second winding frames 3, wherein the first winding frame 2 and each of the second winding frames 3 respectively have plural pins 21, 31 and at least a partition 22, 32. The partition 22 separates at least a primary winding trough 24 on the first winding frame 2 and the partition 32 separates at least a secondary winding trough 34 on each second winding frame 3. Two ends of the first accommodating space 13 respectively have a first opening 11, which is located in a longitudinal direction, and two ends of each second accommodating space 14 respectively have a second opening 12, which is located in a lateral direction. The first frame winding frame 2 and each of the second winding frames 3 respectively have a hollow portion 23, 33 therein, and the hollow portions 23, 33 respectively have openings at two ends thereof for communicating with the first and the second openings 11, 12 respectively, so that the first and the second openings 11, 12 and the hollow portions 23, 33 can form a primary side passage in the longitudinal direction and two secondary side passages in the lateral direction.

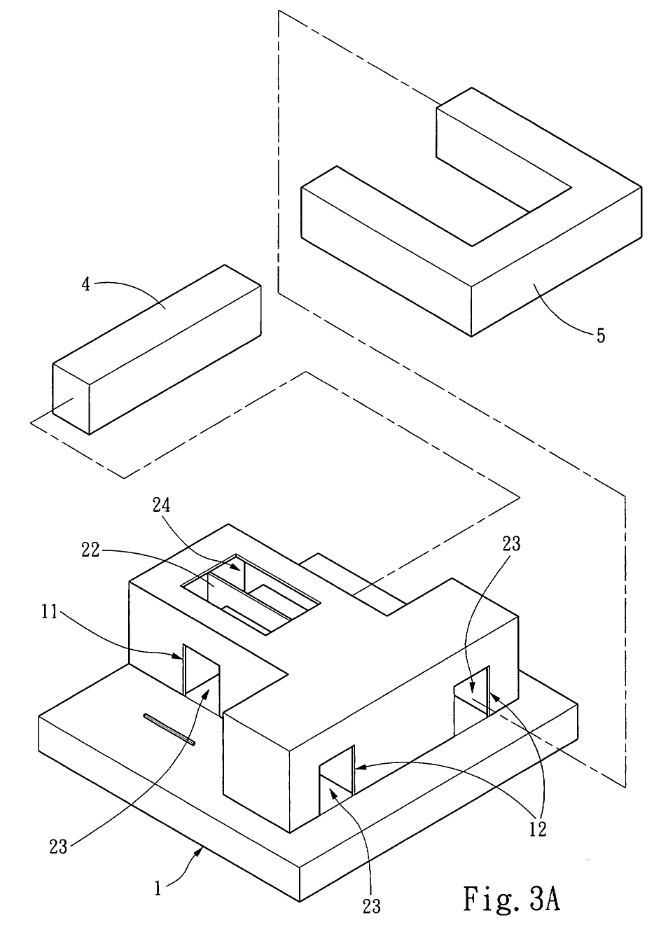

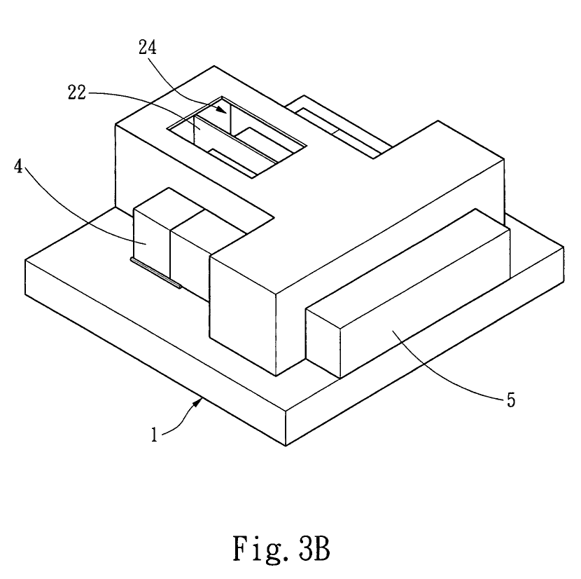

Please refer to FIG. 3A and FIG. 3A. After the main body 1 is combined with the first winding frame 2 and the second winding frames 3 to form the primary side passage and the secondary side passages, a first magnetic material 4 and a second magnetic material 5 respectively penetrate through the primary side passage and the secondary side passages to form a loop, wherein the first magnetic material 4 is I-shaped core and the second magnetic material 5 is a U-shaped core. Since the primary side passage and the secondary side passages are respectively in the longitudinal and the lateral directions, after the I-shaped core penetrates the primary side passage and the U-shaped core penetrates the two secondary side passages, the two ends of the U-shaped core will connect with the two ends of the I-shaped core to form a loop. Then, the first winding frame 2 and the second winding frames 3 will respectively wind the coil on the primary winding trough 24 and the secondary winding troughs 24, so as to form a primary side winding located on the I-shaped core and secondary side windings located at two ends of the U-shaped core, thereby the primary side winding and the secondary side windings may have intervals therebetween, so as to prevent the low voltage feedback of the two secondary side coils from interfering the high voltage coil.

Here, the main body 1, the first winding frame 2 and the second winding frames 3 can be independent elements or can be integrally formed.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An improved transformer structure, applied to provide electricity to plural loads, comprising:
a main body, having a first accommodating space and two accommodating spaces, wherein the first accommodating space has symmetrical first openings mounted thereon in a longitudinal direction and each of two accommodating spaces has symmetrical second openings mounted thereon in a lateral direction; and
a first winding frame and two winding frames, respectively located in the first accommodating space and the two accommodating spaces, wherein the first winding frame has wound thereon a primary side coil and each of the second winding frames has wound thereon a secondary side coil, the first winding frame and the first openings form a primary side passage in the longitudinal direction and the second winding frames and the second openings form two secondary side passages in the lateral direction, and the primary side passage is penetrated by a first magnetic material and the two secondary side passages are penetrated by a second magnetic material, so as to form a transformer capable of converting electricity.

2. The improved transformer structure as claimed in claim 1, wherein the first winding frame and each of the second winding frames respectively have a hollow portion, and two ends of the first winding frame and of each of the second winding frames respectively have openings for communicating with the first openings and the second openings.

3. The improved transformer structure as claimed in claim 1, wherein the first winding frame, the second winding frames and the main body are integrally formed.

4. The improved transformer structure as claimed in claim 1, wherein the first winding frame and the second winding frames are independent components which are respectively embedded into the first accommodating space and the second accommodating spaces of the main body.

5. The improved transformer structure as claimed in claim 4, wherein the first accommodating space and the second accommodating spaces respectively have at least a positioning portion, so as to position the first winding frame and the second winding frames respectively in the first accommodating space and the second accommodating spaces.

6. The improved transformer structure as claimed in claim 1, wherein the first winding frame and the second winding frames further comprise plural pins.

7. The improved transformer structure as claimed in claim 1, wherein the first winding frame has a primary winding trough for winding the primary side coil and the second winding frames have secondary winding troughs for winding the secondary side coil.

8. The improved transformer structure as claimed in claim 7, wherein the first winding frame and each of the second winding frames respectively have at least a partition.

9. The improved transformer structure as claimed in claim 1, wherein the first magnetic material is an I-shaped core.

10. The improved transformer structure as claimed in claim 1, wherein the second magnetic material is an U-shaped core whose two ends are respectively penetrated into the two secondary side passages.
